(19) United States
(12) Patent Application Publication
(10) Pub. No.: US 2023/0029983 A1
(43) Pub. Date: Feb. 2, 2023

(54) SYSTEMS AND METHODS FOR FORECASTING MACROECONOMIC TRENDS USING GEOSPATIAL DATA AND A MACHINE LEARNING MODEL

(71) Applicant: Schneider Economics, LLC, PomPano, FL (US)

(72) Inventor: Jake Schneider, Pompano, FL (US)

(73) Assignee: Schneider Economics, LLC, Pompano, FL (US)

(21) Appl. No.: 17/819,498

(22) Filed: Aug. 12, 2022

Related U.S. Application Data
(63) Continuation of application No. 17/225,461, filed on Apr. 8, 2021, now abandoned.
(60) Provisional application No. 63/008,010, filed on Apr. 10, 2020.

(51) Int. Cl. G06Q 10/04; G06N 20/00; G06Q 40/00; G06F 16/27; G06F 17/18

(52) U.S. Cl. CPC G06Q 10/04; G06N 20/00; G06Q 40/00; G06F 16/27; G06F 17/18

(57) ABSTRACT

A system for forecasting macroeconomic trends using geospatial data and a machine learning model. The system may include a server computing device in communication with a user computing device via a network, the server computing device comprising a processor and a memory, the memory storing computer-executable instructions which are executed by the processor to: obtain images from a satellite imagery catalog; determine Normalized-Difference Built-Up Index (NDBI) values of one or more zones between various bands of the images; determine an average of the NDBI values for each zone; seasonally adjust the average NDBI values; obtain economic data from external sources; generate a stationarity dataset based on the adjusted NDBI values and the economic data; generate a statistical relationship model based on the stationarity dataset and economic activity of each zone; and forecast a macroeconomic trend based on the statistical relationship model and the current satellite imagery data.

### CROSS-REFERENCE TO RELATED APPLICATIONS

The present disclosure is a Continuation of U.S. patent application Ser. No. 17/225,461, filed Apr. 8, 2021, which claims priority to U.S. provisional application No. 63/008,010 filed Apr. 10, 2020, each of the forgoing are hereby incorporated by reference in their entireties.

### BACKGROUND

The subject matter discussed in this background section should not be assumed to be prior art merely as a result of its mention herein. Similarly, any problems mentioned in this background section or associated with the subject matter of this background section should not be assumed to have been previously recognized in the prior art.

Macroeconomics is a branch of economics that studies the behavior of the overall economy operating on a large scale such as national, regional, and global levels. Further, macroeconomics allows entities to determine economy-wide phenomena such as Gross Domestic Product (GDP) for studying economic structure, performance, and behavior of a region(s).

Generally, the macroeconomic trends (e.g. GDP) of a region is based on factors such as the compensation of employees in a region, consumptions of fixed capital in the region, gross operating surplus in the region, subsidies in the region, and taxes on production in the region. Typically, the macroeconomic trends are measured quarterly and generally subject to three revisions before the frontline numbers for economic output are finalized. As such, current methodologies are inadequate as the macroeconomic trends of a particular quarter, for instance, are not fully known until the end of the succeeding quarter i.e., nearly three months after a particular quarter has ended.

Currently, the New York and Atlanta Federal Reserve Banks produce estimates of GDP in near real-time (e.g., weekly) in the publicly available service “NowCast” (a statistical model). A short-coming, however, is that such services use extrapolations of past data and small economic data inputs as they become available thereby rendering the estimation rather unreliable, backward looking, and slow/inefficient.

As an example, the GDP report is published quarterly and revised monthly. The GDP for a given quarter is released in the first month following a quarter as the “advance estimate”. The “preliminary estimate” is published in the second month, followed by the “revised” estimate in the third month. Further, various other financial firms use “alternative financial datasets” to, for instance, prognosticate stocks that are likely to be successful or use robotics to analyze crop and weather data to automate daily farming tasks. Such firms provide earth observation data, geo-spatial data, satellite technology and AI, location-based insights on foot traffic patterns, and AI for real-time location of mobile phones, respectively.

In other examples, financial firms use drones to take pictures of 1) cars in parking lots in order to forecast sales, 2) farm fields at the plant level to identify plant health and/or disease, and 3) building assets to forecast insurance needs, and the like. Where the prior art fails in relation to the present disclosure is that they focus on forecasting for individual companies and not for the macroeconomy where predicting the real-time GDP of a large-scale region such as a city, state, or a country is heretofore unmet.

Related art, for various aspects contained therewithin, relevant to this disclosure includes, 1) U.S. Pat. No. 10,182,214 B2 to Amihay Gornik, 2) U.S. Pat. No. 10,319,107 B2 to Boris Aleksandrovich Babenko, 3) U.S. Pat. No. 10,282,821 B1 to Michael S. Warren, 4) Chinese Patent Application Publication No. 108416479 A to Liangbing et. al, 5) Chinese Patent Application Publication No. 106503838 A to Chang et. al, 6) Chinese Patent Application Publication No. 106779290 A to MA Congvong, 7) Chinese Patent Application Publication No. 106156894 A to Ling et. al, 8) Chinese Patent Application Publication No. 106600029 A to Jinhua et. al, 9) U.S. Pat. No. 8,364,569 B1 to Lee, and 10) U.S. Patent Application Publication US2019/0188811 A1 to Sasson. The related art is incorporated herein by reference.

Although a recent addition to the economics literature, the use of satellite imagery for estimating economic activity is already becoming well-established. Doll, Muller, and Morley (2006) proved that nightlight imagery was correlated with GDP for 11 European countries as well as the United States. Numerous other studies have followed that corroborate these results, including Ghosh et al. (2010), Nordhaus and Xi (2011), and Henderson, Storeygard, and Weil (2012). These studies are incorporated herein by reference.

All of these previous studies utilized night-time luminosity data in order to proxy economic activity. Although this technique is viable, the nightlight methodology is vastly restricted by its ability to discern relative differences in economic activity across geographies. For instance, luminosity is largely binary insofar as a location either has it or it does not, and therefore lumens do not accurately reflect increasing layers of economic complexity. Jean et al. (2016), incorporated herein by reference, provides a different approach: day-time imagery of features in the environment to proxy economic activity.

### BRIEF DESCRIPTION OF DRAWINGS

The file of this patent contains at least one drawing executed in color. Copies of this patent with color drawings will be provided by the Patent and Trademark Office upon request and payment of the necessary fee.

Other objects and advantages of the present disclosure will become apparent to those skilled in the art upon reading the following detailed description of exemplary embodiments, in conjunction with the accompanying drawings, in which like reference numerals have been used to designate like elements, and in which:

FIG. 1 shows flowchart for a method for forecasting macroeconomic trends using geospatial data according to an example embodiment of the present disclosure;

FIG. 2 shows a zone layer, value layer and output layer according to an example embodiment of the present disclosure;

FIG. 3 shows NDBI zonal statistics for every US state according to an example embodiment of the present disclosure;

FIG. 4 shows NDBI seasonal adjustment graph for U.S. state of Alabama according to an example embodiment of the present disclosure;

FIGS. 5A and 5B illustrate examples of economic data obtained from external sources according to an example embodiment of the present disclosure;

FIG. 6 shows time-series data and a new first-differenced variable from the underlying values according to an example embodiment of the present disclosure;

FIG. 7A shows data before being first-differenced according to an example embodiment of the present disclosure;

FIG. 7B shows data after the first-differencing according to an example embodiment of the present disclosure;

FIG. 8 shows stationarity for NDBI for US state of Alabama according to an example embodiment of the present disclosure;

FIG. 9A shows seasonally adjusted NDBI facet graphs according to an example embodiment of the present disclosure;

FIG. 9B shows real GDP graphs according to an example embodiment of the present disclosure;

FIG. 10 illustrates a relationship between the percent changes of NDBI and state-level real GDP of AL and AR according to an exemplary embodiment of the present disclosure;

FIG. 11 shows regression results according to exemplary embodiment of the present disclosure;

FIG. 12 shows regression results according to exemplary embodiment of the present disclosure;

FIG. 13 shows regression results according to exemplary embodiment of the present disclosure;

FIG. 14 illustrates nowcasting technique of prediction according to exemplary embodiment of the present disclosure;

FIG. 15A shows regression results according to exemplary embodiment of the present disclosure;

FIG. 15B shows regression results according to exemplary embodiment of the present disclosure;

FIG. 16 shows a system diagram for forecasting macroeconomic trends using geospatial data according to an exemplary embodiment of the present disclosure; and

FIG. 17 illustrates a machine configured to perform computing operations according to an embodiment of the present disclosure.

### SUMMARY

A computer-implemented method for forecasting macroeconomic trends using geospatial data and a machine learning model is disclosed. The method may include obtaining images from a satellite imagery catalog; determining Normalized-Difference Built-Up Index (NDBI) values of one or more zones between various bands of the images; determining an average of the NDBI values for each zone; seasonally adjusting the average NDBI values; obtaining economic data from external sources; generating a stationarity dataset based on the adjusted NDBI values and the economic data; generating a statistical relationship model (i.e. machine learning model) based on the stationarity dataset and economic activity of each zone; and forecasting a macroeconomic trend based on the statistical relationship model and the current satellite imagery data.

In various example embodiments, the macroeconomic trend can be Gross Domestic Product (GDP). The statistical relationship model can be based on at least one machine learning algorithm such as a regression algorithm. The external sources may include Federal Reserve Bank of St. Louis (FRED) and/or the Bureau of Economic Analysis (BEA). The satellite imagery catalog can be Google Earth Engine. Each zone can be a state of the United States.

In various example embodiments, the method may include compiling and/or exporting the macroeconomic trend to an external destination. The external destination can be a user-access portal that allows authenticated users to view and download the macroeconomic trend. The external destination can be a blockchain based distributed ledger that records the macroeconomic trend.

A system for forecasting macroeconomic trends using geospatial data and a machine learning model is disclosed. The system may include a processor and a memory, the memory storing computer-executable instructions which are executed by the processor to: obtain images from a satellite imagery catalog; determine NDBI values of one or more zones between various bands of the images; determine an average of the NDBI values for each zone; seasonally adjust the average NDBI values; obtain economic data from external sources; generate a stationarity dataset based on the adjusted NDBI values and the economic data; generate a statistical relationship model (i.e. machine learning model) based on the stationarity dataset and economic activity of each zone; and forecast a macroeconomic trend based on the statistical relationship model and the current satellite imagery data.

### DESCRIPTION

The present disclosure provides technique that utilizes machine learning models to forecast macroeconomic trends. The disclosed techniques can estimate macroeconomic trends (e.g. Gross Domestic Product (GDP)) continuously and in real-time using daylight imagery from satellites that continuously circumnavigate the globe at high orbit. The disclosed techniques that are based on machine learning consume fewer computing resources, thereby providing improvements in computing technology.

The methodology underpinning these techniques can be generally encapsulated in a few high-level stages. First, the urbanization data from satellite imagery from past and present snapshots of Earth can be culled, cleaned and transformed into numerical statistics utilizing remote sensing, band math and zonal statistics. Second, a machine learning model can be built that establishes a statistical relationship between the satellite urbanization data and economic activity, as measured by backward-looking macroeconomic estimates. Third, the statistical relationship can be utilized in combination with current satellite images to predict real-time economic activity for a place of interest. Fourth, official economic activity can be predicted prior to formal government statistical releases to confirm the accuracy of the algorithm and further finetune the statistical learning formula for future real-time predictions, as necessary. In various example embodiments, the order of these four stages can be different and some of the stages can be optional. Further, each of the four stages can have various sub-stages and the output of the stages/sub-stages can be exported in real-time to customers through a data portal in human- and machine-readable formats (e.g. CSV, XLSX, APIs, etc.), recorded in a local memory, a cloud based server and/or a blockchain based distributed ledger.

In an example embodiment, new satellite imagery obtained in stage 1 can continually reinform the statistical learning mathematical model in stage 2, which can be further re-configured by the accuracy of its predictions compared to government releases in stage 4, allowing for better real-time predictions in stage 3. The real-time statistics can then be released to consumers in near real-time (e.g., weekly, daily, and/or sub-daily periods). Each of the stages and sub-stages are subsequently described in detail.

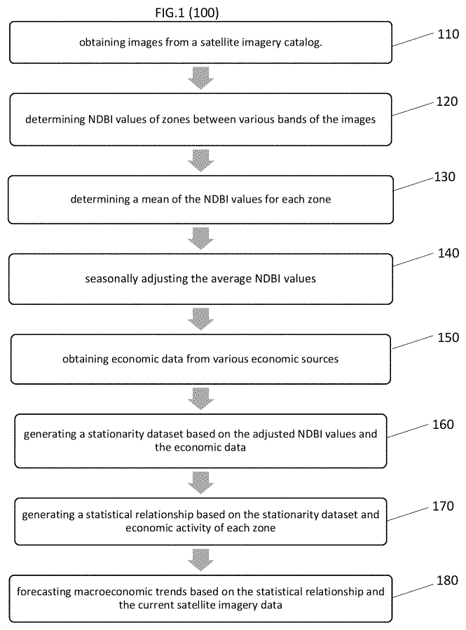

FIG. 1 shows a flowchart for an example method 100 for forecasting macroeconomic trends using geospatial data based on the disclosed techniques. The method 100 may include a step 110 of obtaining images (e.g. Landsat images from Landsat satellites 4 through 8) from a satellite imagery catalog (e.g. Google Earth Engine (GEE)). Known algorithms to obtain images can be used for step 110.

In an example and non-limiting embodiment, the step 110 may entail using daylight imagery from the Landsat Program combined with remote sensing to obtain images. Of course, other known methods can be used to obtain images in step 110. The obtained images can optionally be filtered based on cloud cover and/or date to obtain Tier 1 (best) imagery.

The method 100 may include a step 120 of determining Normalized-Difference Built-Up Index (NDBI) values of zones (e.g. geographical areas) between various bands of the images obtained in step 110. In various example embodiments, the bands in step 120 may be selected from a group including 0.43-0.45 um band, 0.45-0.51 um band, 0.53-0.59 um band, 0.64-0.67 um band, 0.85-0.88 um band, 1.57-1.65 um band, 2.11-2.29 um band, 0.50-0.68 um band, 1.36-1.38 um band, 10.6-11.9 um band, and 11.50-12.51 um band. Further, the bands may be selected based on the type of satellite, without departing from the scope of the disclosure.

The method 100 may include a step 130 of determining a mean (average) of the NDBI values for each zone. Step 130 can be performed by utilizing the remote sensing technique of a zonal statistic process, as described in https://desktop.arcgis.com/en/arcmap/10.3/tools/spatial-analyst-toolbox/h-how-zonal-statistics-works.htm (April 2021), incorporated herein by reference. The average of the NDBI values can be collated into numerical statistics within a dataset.

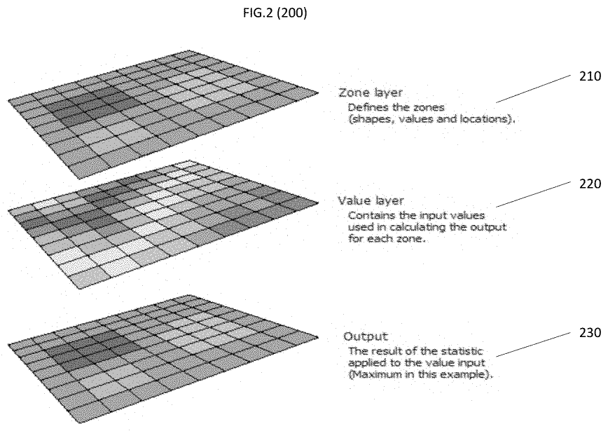

FIG. 2 shows an exemplary zone layer 210, value layer 220 and output layer 230 that can be used calculate the mean NDBI value for each US state (i.e. the zones). The zone layer 210 may define the zones (e.g. the shapes, values and geographic locations). In an example embodiment, the zone can be a US state. The value layer 220 may contain the input values in calculating the output of each zone. In an example embodiment, value layer can be the NDBI values for each individual geotiff square tile. The output layer 230 can be a result of the aforementioned zonal statistic process applied to the input values.

The NDBI values determined in step 120 can be based on the short-wave infrared radiation (SWIR) and near infrared radiation (NIR) waves picked up by the sensors on satellites, and the band math between these radiation spectroscopy spectrums. That is, NDBI=(SWIR−NIR)/(SWIR+NIR).

As an example of determining the NDBI value in step 120, a single geotiff tile might have a SWIR value of 1.2 microns and NIR value of 0.9 microns, which, when calculated through the aforementioned NDBI formula, would equal an NDBI value of approximately 0.14. Another geotiff tile might have values of 1.1 and 1.6 microns yielding an NDBI score of approximately −0.19, and a third tile might have values of 1.7 and 0.7 microns, yielding a NDBI score of approximately 0.42. The NDBI values are between −1 and 1.

With all three of these tiles are in the same geographical zone, then, using the zonal statistics described previously, the three NDBI values can be averaged as such utilizing the mean formula:

$$\overline{NDBI} = \frac{{NDBI}_{1} + {NDBI}_{2} + {NDBI}_{3}}{3} = \frac{0.14 - 0.19 + 0.42}{3} \approx 0.12$$

This averaging of the individual scores can yield a single score for the entire geographical zone of 0.12. According to the paper on the NDBI from Zha, Gao and Ni (2003), incorporated herein by reference, an average NDBI value of 0.12 may signify an area of modest urbanization. In general, average (mean) NDBI scores above 0 signify more urbanization than vegetation, while values below 0 demonstrate the opposite.

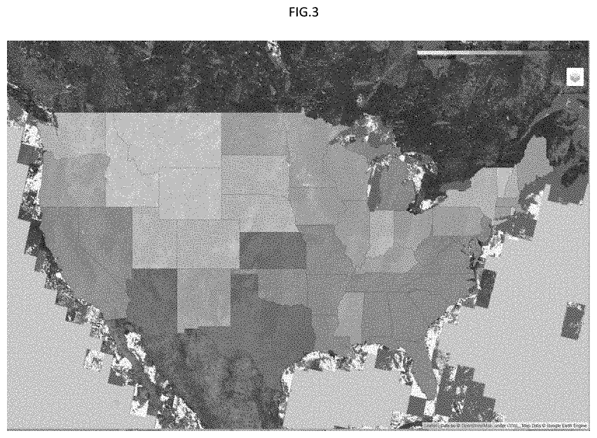

FIG. 3 shows exemplary NDBI zonal statistics for every US state in 2015 by overlaying the mean NDBI score for every state of the US over a map of North America's NDBI scores for the first quarter of 2015. While FIG. 3 is sourced from the Google Earth Engine platform and API to pull the Landsat images and calculate the zonal statistics, there are numerous alternatives for all of the above steps including locating the necessary images on other cloud servers (e.g., Amazon S3, Microsoft Azure) or by purchasing the Landsat images directly from the USGS and NASA. In addition, both the NDBI and zonal statistics can be calculated using other geospatial software (e.g. ArcGIS Pro, QGIS, Global Mapper).

The method 100 may include a step 140 of seasonally adjusting the average NDBI values determined in step 130 that may have certain seasonal patterns that obscure the true trend of the values. For example, ice cream sales are consistently higher during summer months than the winter, and, therefore, to compare the two periods, seasonal adjustment needs can be conducted to correct for time-consistent differences.

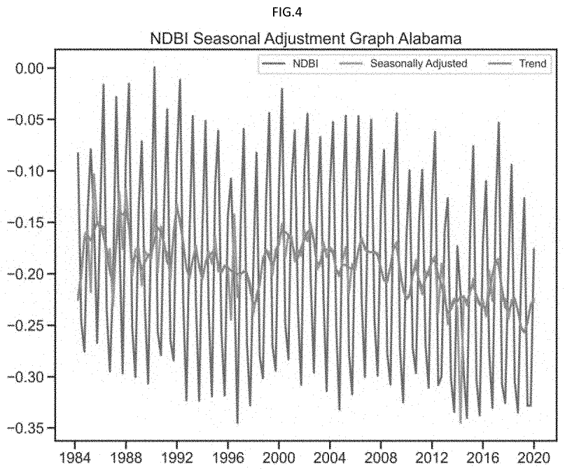

In an example embodiment, the step 140 can be performed by utilizing the X-13 ARIMA-SEATS, a computer program produced by the US Census Bureau (US Census Bureau 2017). Of course, other similar known programs can be used without departing from the scope of the present disclosure. FIG. 4 shows NDBI seasonal adjustment graph for U.S. state of Alabama. Similarly, step 140 can be used to generate NDBI seasonal adjustment graph for other U.S. states and zones.

The method 100 may include a step 150 of obtaining economic data from various economic sources (e.g. official government sources such as the Federal Reserve Bank of St. Louis (FRED) and the Bureau of Economic Analysis (BEA)). In an example embodiment, FRED can provide U.S. national-level statistics and the BEA can provide state-level statistics. Known algorithms to obtain data can be used for step 150.

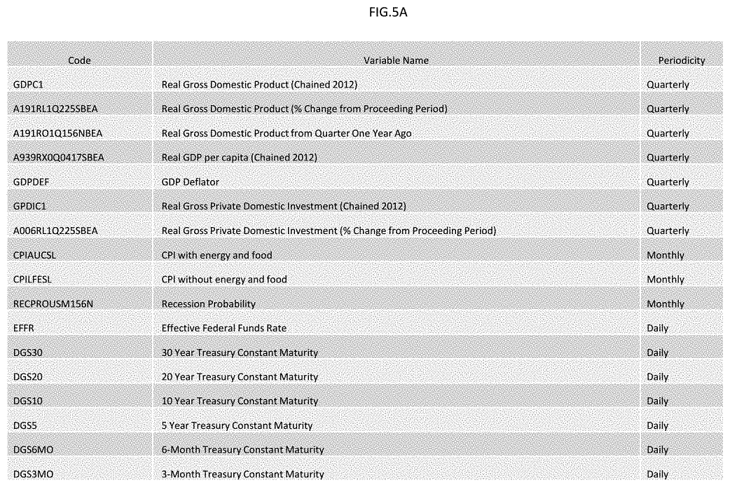

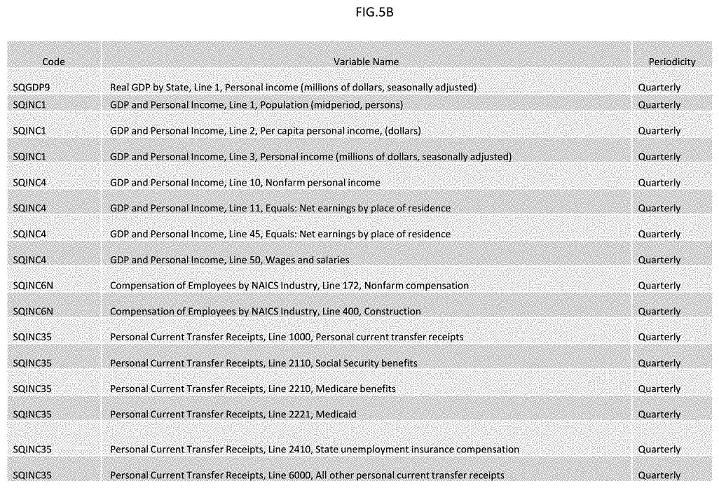

FIGS. 5A and 5B provide non-limiting examples of the economic data that can be obtained in step 150. FIG. 5A illustrates economic data obtained from FRED. FIG. 5B illustrates economic data obtained from BEA. The economic data in these figures is illustrated by a unique code, type/description of data (aka variable name) and a frequency of recording. It will be apparent to one skilled in the art that such an illustration of the economic data is a non-limiting example.

The method 100 may include a step 160 of generating a stationarity dataset based on the adjusted NDBI values obtained in step 140 and the economic data obtained in step 150. The step 160 can include merging the seasonally adjusted NDBI values obtained in step 140 and the economic data in step 150 to obtain a merged dataset that contains multiple variables. The merging can occur along the state, year, and quarter variables. The merged dataset can then be converted from nominal to real (inflation adjusted) values, as necessary. Known techniques (e.g. techniques utilizing common index features) can be used for the merging.

After the merging, the step 160 can include combining multiple variables in the merged dataset to obtain custom variables such as state-level GDP per capita and national-level yield spreads (e.g., the US 30 Year Constant Maturity Bond less the US 10 Year Constant Maturity Note, etc.). The percent change (PC) and annualized percentage change (APC) can be calculated for all variables, and then the first difference of each of these variations can be calculated for on-the-level, PC and APC.

A first-differencing of the custom variables can then be performed to obtain the stationarity dataset such that the trend of the data is centered on zero and mean-reverting over time. First-differencing is a technique for achieving stationarity of a time-series variable, which is mean-reverting across time observations. This can allow in achieving consistent forecasts. While many techniques can be used to achieve stationarity, the present disclosure provides a detailed description of the first-differencing technique. Other techniques may include detrending utilizing regression analysis and variable transformations.

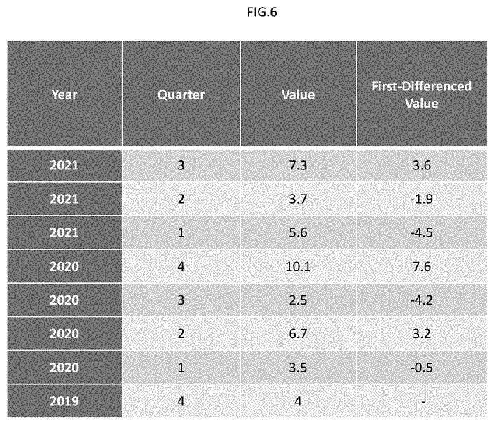

FIG. 6 shows time-series data and a new first-differenced variable from the underlying values. By graphing both ‘value’ and ‘first-differenced value’ the point for creating stationarity in the time-series data can be seen. First-differencing can be calculated by subtracting a variable's current period observation by the previous period and continuing this process for all of the previous observations. In mathematical notation, the formula can be:

θVar_{i,t}=Var_{i,t}−Var_{i,t-1}, where i is the observation of the variable and t is time

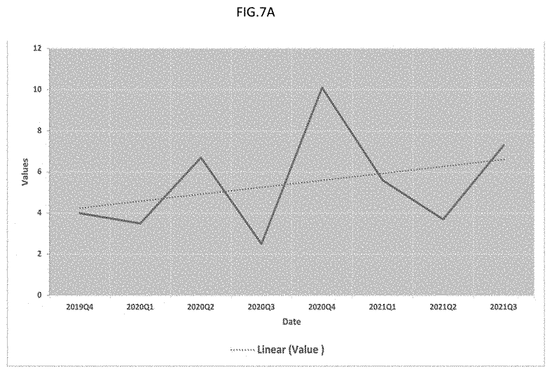

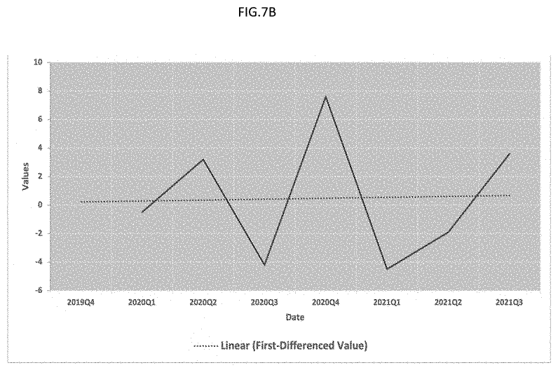

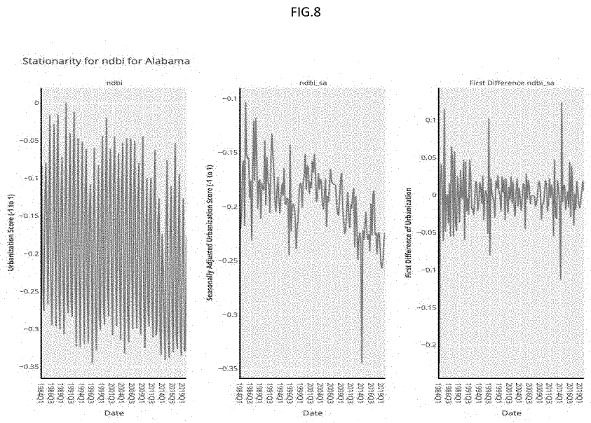

FIG. 7A shows the data before being first-differenced and it has an upward trend. In contrast, FIG. 7B shows the data after the first-differencing and it has nearly no trend. FIG. 8 shows an example stationarity for NDBI for US state of Alabama using the aforementioned technique. The variables can then be transformed using quadratic terms (squared, cubed, and fourth power), and then all of these forms can be lagged up to 12 quarters. The output in the form of the stationarity dataset can then be saved and/or outputted.

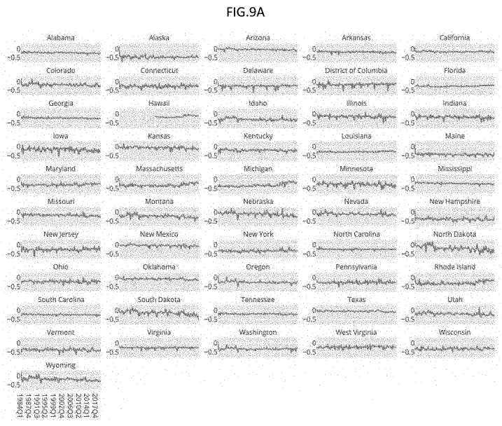

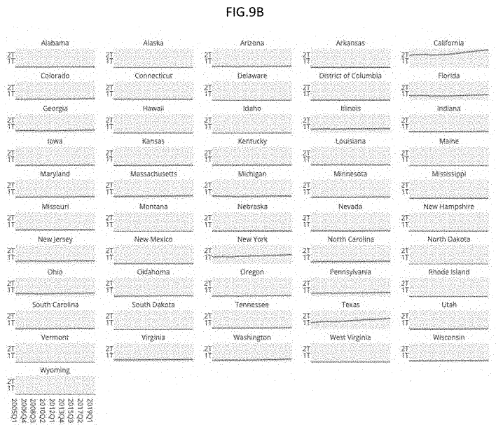

The method 100 can include a step 170 of generating a statistical relationship model based on the stationarity dataset and economic activity of each zone. FIG. 9A and FIG. 9B show seasonally adjusted NDBI facet graphs and real GDP for each of the 50 US states and District of Columbia respectively to be used in step 170.

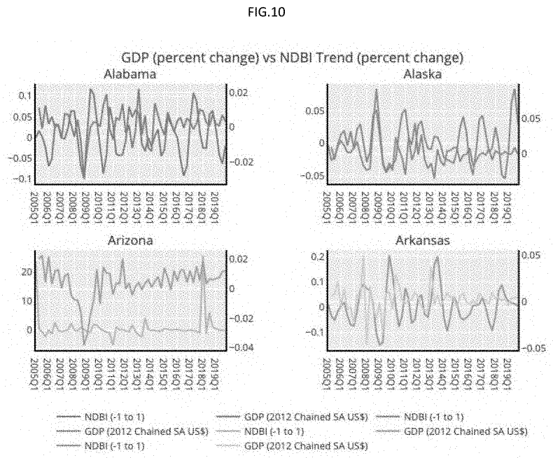

FIG. 10 illustrates a relationship between the percent changes of NDBI and state-level real GDP using the US states of Alabama and Arkansas as examples. Similar relationship can be illustrated for the other states. There can be a strong relationship between the satellite urbanization data and state economic activity levels. To quantify the magnitude, direction and statistical significance of this relationship, various machine learning models can be utilized. The present disclosure describes the regression model in detail, but it will be appreciated by those skilled in the art that other machine learning models such as random forest, boosting, bagging, neural networks, etc. can also be similarly used.

To avoid spurious models rife with omitted variable bias, the backward selection can be utilized to fit the regression model in order to test individual combinations of different economic data. To forecast accurate prediction, a maximum number of high-frequency data points can be included in the regression specification to maximize both the total predictive capability of the model (as measured by R²) while simultaneously achieving statistical significance on all variables in the economic data.

In an example embodiment, over 200 regressions can be implemented to test various combinations of variables, quadratic terms, interaction terms, leads, lags, and fixed effects. Three best regressions can be identified. First, to test the explanatory power and statistical significance of the satellite urbanization data on its own without economic data, the first difference of the seasonally adjusted NDBI (‘ndbi_sa_diff1’) can be regressed on the first difference of state-level real GDP (‘SQGDP9_1_diff1’) utilizing a state-level and year fixed effects specification. Through preliminary regressions and statistical tests (e.g. the Hausman-Wu Test), fixed effects can be identified to maximize the statistical variation of the underlying panel data by essentially ‘grouping’ the individual values according to their underlying state and year groupings.

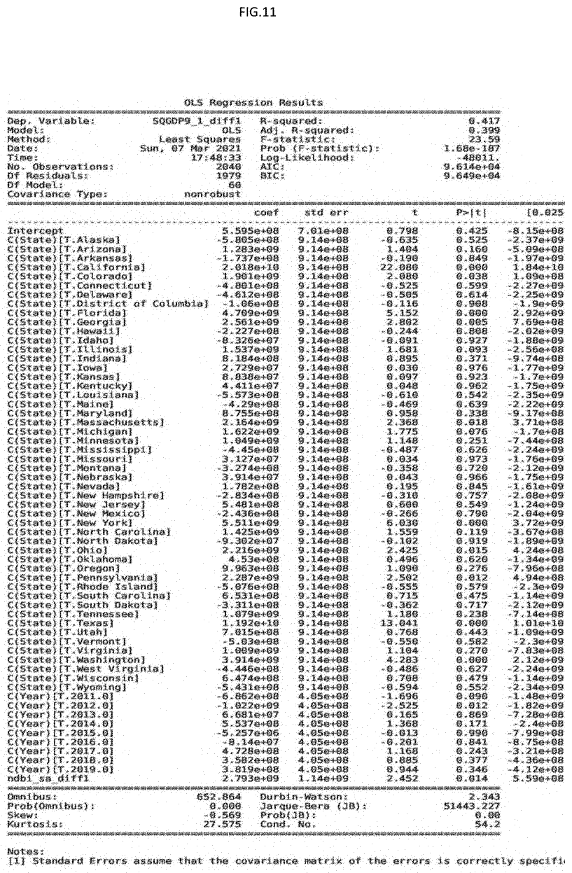

FIG. 11 shows example regression results based on a regression that is the baseline analysis showing the relationship between the cleaned NDBI (satellite) data and the cleaned GDP. This regression utilizes dependent (Y) Variable: State-Level Real Seasonally Adjusted GDP, first differenced (‘SQGDP_1_diff1’) and independent (X) Variable: State-Level Real Seasonally Adjusted NDBI, first differenced (‘ndbi_sa_diff1’).

NDBI can be statistically significantly related to GDP when regressed alone as demonstrated by a t-statistic of 2.45 (surpassing the necessary cutoff threshold of 2). In addition, the coefficient on NDBI can be both positive and appropriate in magnitude, further confirming the reliability of this NDBI variable. The most notable value from this regression can be the R² (‘R-squared’) of the model at 41.7%. This value may suggest that the inclusion of NDBI on its own accounted for nearly half of the variation in the GDP data. Finally, other values in the regression output can also suggest an extremely strong model, including an F-statistic of 23.6 (10 is generally considered significant), and a Jarque-Bera (JB) Condition Number of 54.2, suggesting little multicollinearity.

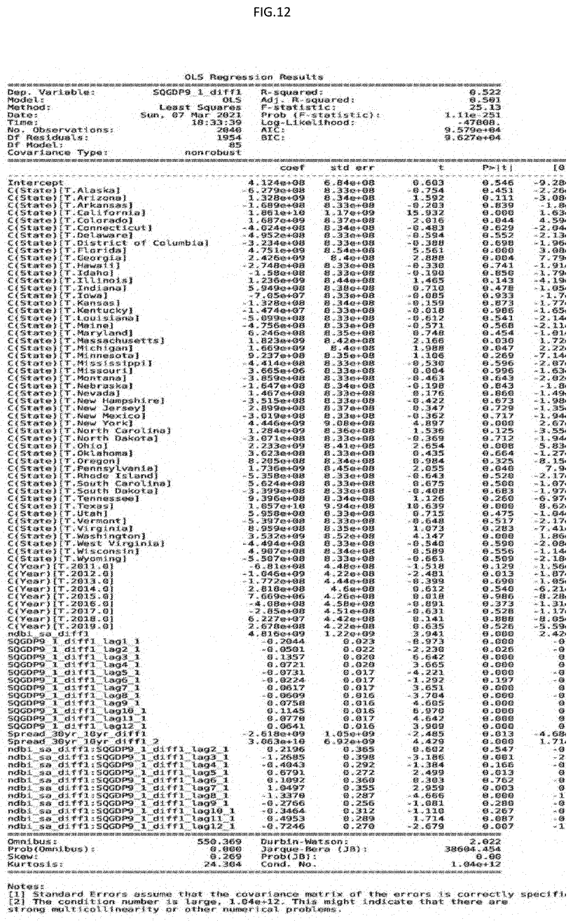

FIG. 12 shows results of another example regression that may include additional covariates to increase the R² of the model while also only utilizing daily variables. This regression utilizes dependent (Y) Variable: State-Level Real Seasonally Adjusted GDP, first differenced (‘SQGDP_1_diff1’) and independent (X) Variables: Satellite Data: State-Level Real Seasonally Adjusted NDBI, first differenced (‘ndbi_sa_diff1’); Past GDP Momentum Factor: Lagged State-Level Real Seasonally Adjusted GDP, first differenced for quarters 1 through 12 (ex. ‘SQGDP_1_diff1_lag5’); Yield Spread: Difference between the quarterly average 30 Year Treasury Bond and the 10 Year Treasury Note, first difference (‘Spread_30Yr_10yr_diff1’); Yield Spread Squared: Squared difference between the quarterly average 30 Year Treasury Bond and the 10 Year Treasury Note, first difference (‘Spread_30Yr 10yr_diff1_2’); and Interaction Term Between Satellite Data & Lagged GDP: Multiplying Satellite Data by Past GDP Momentum Factor as individual variables (ex. ‘ndbi_sa_diff1:SQGDP_9_1_diff1_lag5_1’).

Daily data can be important to maintain the ability to run the algorithm in near real-time. After including lagged terms for GDP (e.g., a momentum term), an interaction term between GDP and NDBI, and national-level yield spreads, the predictive capability of the model may increase by nearly 10 percentage points to 52.2%, while also maintaining the statistical significance of the NDBI variable. In fact, NDBI's t-statistic increased to 3.9, well above the threshold of 2. The inclusion of these additional variables may introduce the possibility of multicollinearity.

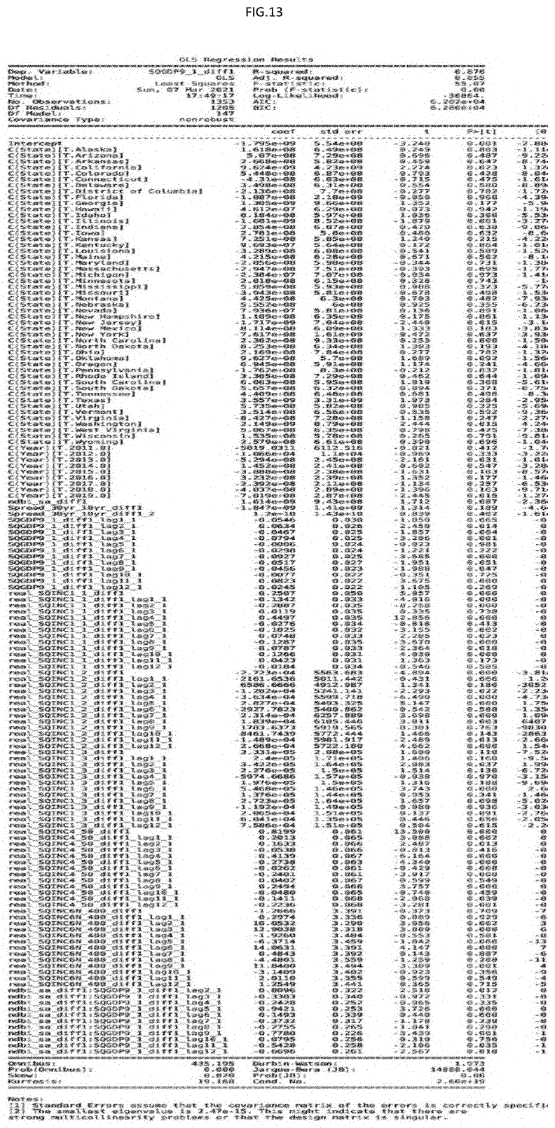

FIG. 13 shows results of another example regression based on a technique of including numerous statistically significant covariates. By including additional covariates, such as the yield spread, lagged GDP, population, personal income, construction spending, and several interaction terms, the model yields an R² of 87.0%. This suggests that this model explains nearly all of the variation inherent in predicting state-level GDP.

This regression utilizes Dependent (Y) Variable: State-Level Real Seasonally Adjusted GDP, first differenced (‘SQGDP_1_diff1’) and Independent (X) Variables: Satellite Data: State-Level Real Seasonally Adjusted NDBI, first differenced (‘ndbi_sa_diff1’); Past GDP Momentum Factor: Lagged State-Level Real Seasonally Adjusted GDP, first differenced for quarters 1 through 12 (ex. ‘SQGDP_1_diff1_lag5’); Yield Spread: Difference between the quarterly average 30 Year Treasury Bond and the 10 Year Treasury Note, first difference (‘Spread_30Yr_10yr_diff1’); Yield Spread Squared: Squared difference between the quarterly average 30 Year Treasury Bond and the 10 Year Treasury Note, first difference (‘Spread_30Yr 10yr_diff1_2’); and Interaction Term Between Satellite Data & Lagged GDP: Multiplying Satellite Data by Past GDP Momentum Factor as individual variables (ex. ‘ndbi_sa_diff1:SQGDP_9_1_diff1_lag5_1’). Other explanatory variables may include state population, personal income and construction.

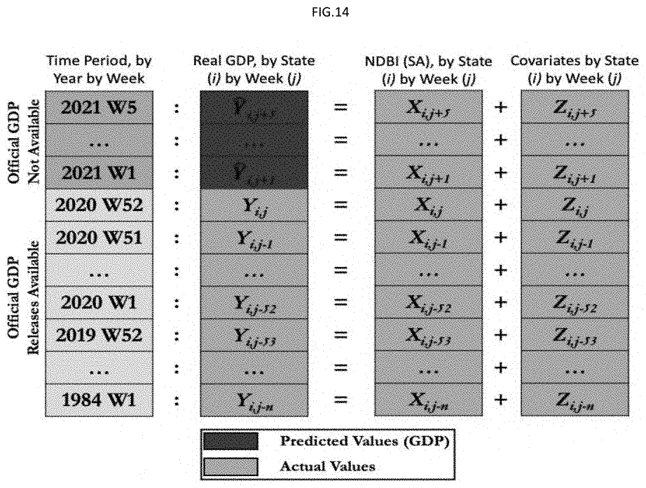

The method 100 may include a step 180 of forecasting macroeconomic trends (e.g. GDP) based on the statistical relationship model and the current satellite imagery data. The step 180 can be based on a Nowcasting technique illustrated in FIG. 14 and described in detail as follows. Using weekly data and previously described regression specifications a statistical learning model can be built. This model can relate the two leftmost columns (variables X and Z) to the center column of Y from 1984 Week 1 to 2020 Week 52. This may build a mathematical relationship between state-level GDP (Y) and the satellite urbanization data (X), including the covariates (Z). As official GDP is not a weekly statistic, a linear interpolation can be used to transform the current quarterly GDP statistics into weekly data for the backward-looking models.

In an example embodiment, to nowcast GDP, the algorithm continues utilizing the weekly statistical learning model culled from the officially released, backward-looking data and carries forward the mathematical specifications to predict present GDP. As the Landsat satellites continue to orbit the Earth photographing the surface in real-time, the inventor continues to run the Region Reducer Function up to the present moment and then plugs these urbanization values into the algorithm to forecast current GDP. Thus, as the satellites circumnavigate the globe every 20 minutes, the algorithm can proxy economic activity continuously, in near real-time (US Geological Survey n.d.).

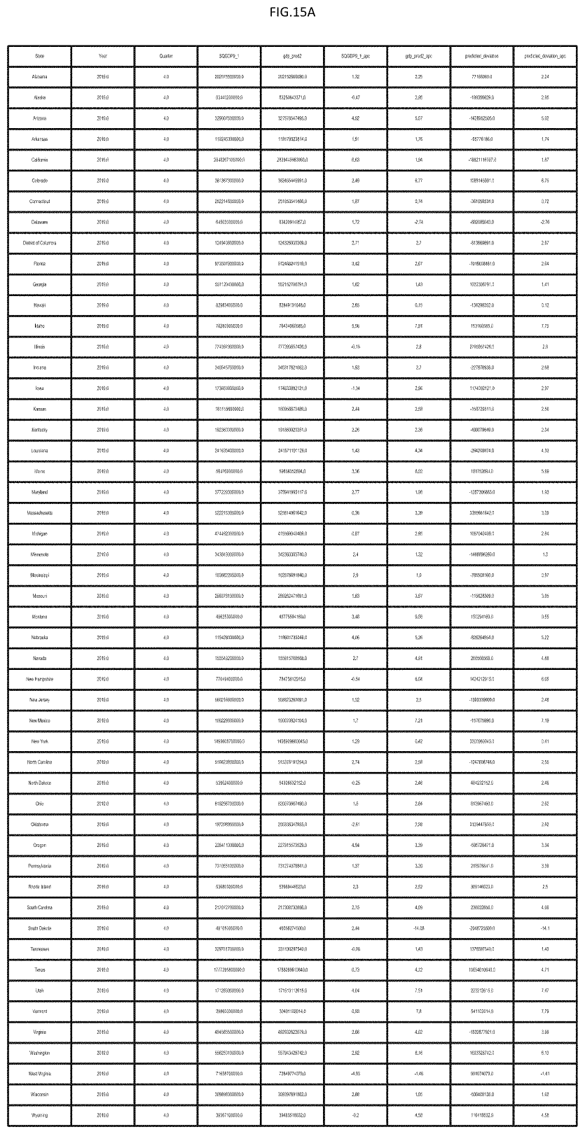

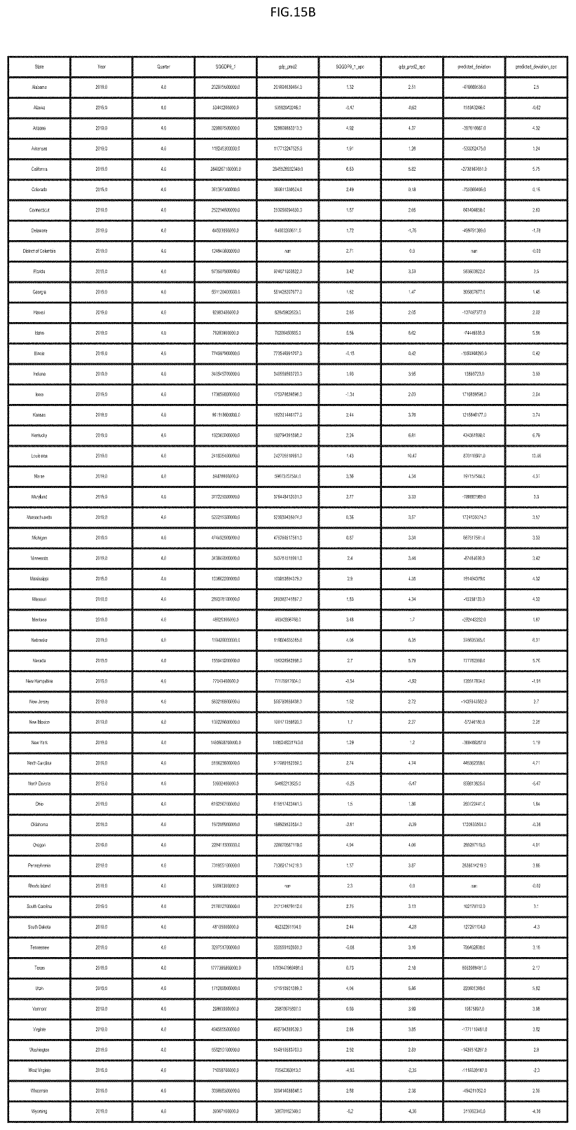

In an example embodiment, one or more steps of method 100 can be retuned to be modulated with the newest official GDP releases from the BEA or other sources. To verify the predictive accuracy of the algorithm, the statistical learning model can be utilized to predict backward-looking state-level GDP values. For example, FIG. 15A shows results by US state for 2019, Quarter 4 using a regression technique similar to the one used for FIG. 12's results. FIG. 15B shows regression results by US state for 2019, Quarter 4 using a regression technique similar to the one used for FIG. 13's results.

In an example embodiment, when the results from columns ‘SQGDP9_1_apc’ to ‘gdp_pred2_apc’ are compared for FIG. 15A and FIG. 15B, the predicted values can be similar to the actual BEA values. The precision of these estimates can improve when more complicated machine learning algorithms such as random forest and neural networks are employed.

In an example embodiment, the macroeconomic trends forecasted by the method 100 can be compiled and exported using known techniques. For example, a user-access portal can be used that will allow authenticated users to view and download the products that they subscribe to onto their local devices (e.g. CSV, XLSX, etc. files). In addition, authenticated users may access the forecasts via known programs such as Microsoft Excel or computer programming languages such as Python and R. The trends can also reach users via weekly or monthly newsletters.

In an example embodiment, the macroeconomic trends forecasted by the method 100 can be recorded in a local memory, a cloud-based server and/or a blockchain based distributed ledger. In a blockchain, the records can be stored in the order that the records are received. Each node in the blockchain network has a complete replica of the entire blockchain. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified.

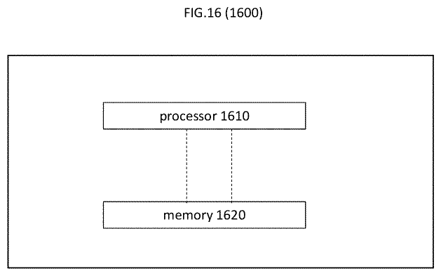

FIG. 16 shows a system 1600 for forecasting macroeconomic trends using geospatial data, the system 1600 comprising a processor 1610 and a memory 1620, the memory 1620 storing computer-executable instructions which are executed by the processor 1610.

In an example embodiment, these computer-executable instructions cause the processor 1610 to obtain images from a satellite imagery catalog, determine NDBI values of one or more zones between various bands of the images, and determine an average of the NDBI values for each zone. This is similar to aspects of previously described steps 110, 120 and 130 respectively.

The computer-executable instructions may further cause the processor 1610 to seasonally adjust the average NDBI values, obtain economic data from external sources and generate a stationarity dataset based on the adjusted NDBI values and the economic data. This is similar to aspects of previously described steps 140, 150 and 160 respectively

The computer-executable instructions may further cause the processor 1610 to generate a statistical relationship model based on the stationarity dataset and economic activity of each zone; and forecast a macroeconomic trend based on the statistical relationship model and the current satellite imagery data. This is similar to aspects of previously described steps 170 and 180 respectively.

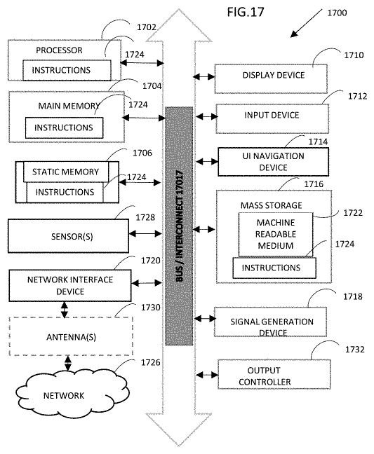

FIG. 17 is a block diagram illustrating an example computer system 1700 upon which any one or more of the methodologies (e.g. method 100 and/or system 1600) herein discussed may be run according to an example described herein. Computer system 1700 may be embodied as a computing device, providing operations of the components featured in the various figures, including components of the system 1600, method 100, or any other processing or computing platform or component described or referred to herein.

In alternative embodiments, the computer system 1700 can operate as a standalone device or may be connected (e.g., networked) to other machines. In a networked deployment, the computing system 1700 may operate in the capacity of either a server or a client machine in server-client network environments, or it may act as a peer machine in peer-to-peer (or distributed) network environments.

Example computer system 1700 includes a processor 1702 (e.g., a central processing unit (CPU), a graphics processing unit (GPU) or both), a main memory 1704 and a static memory 1706, which communicate with each other via an interconnect 1708 (e.g., a link, a bus, etc.). The computer system 1700 may further include a video display unit 1710, an input device 1712 (e.g. keyboard) and a user interface (UI) navigation device 1714 (e.g., a mouse). In one embodiment, the video display unit 1710, input device 1712 and UI navigation device 1714 are a touch screen display. The computer system 1700 may additionally include a storage device 1716 (e.g., a drive unit), a signal generation device 1718 (e.g., a speaker), an output controller 1732, and a network interface device 1720 (which may include or operably communicate with one or more antennas 1730, transceivers, or other wireless communications hardware), and one or more sensors 1728.

The storage device 1716 includes a machine-readable medium 1722 on which is stored one or more sets of data structures and instructions 1724 (e.g., software) embodying or utilized by any one or more of the methodologies or functions described herein. The instructions 1724 may also reside, completely or at least partially, within the main memory 1704, static memory 1706, and/or within the processor 1702 during execution thereof by the computer system 1700, with the main memory 1704, static memory 1706, and the processor 1702 constituting machine-readable media.

While the machine-readable medium 1722 (or computer-readable medium) is illustrated in an example embodiment to be a single medium, the term “machine-readable medium” may include a single medium or multiple medium (e.g., a centralized or distributed database, and/or associated caches and servers) that store the one or more instructions 1724.

The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions.

The term “machine-readable medium” shall accordingly be taken to include, but not be limited to, solid-state memories, optical media, magnetic media or other non-transitory media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 1724 may further be transmitted or received over a communications network 1726 using a transmission medium via the network interface device 1720 utilizing any one of several well-known transfer protocols (e.g., HTTP). Examples of communication networks include a local area network (LAN), wide area network (WAN), the Internet, mobile telephone networks, Plain Old Telephone (POTS) networks, and wireless data networks (e.g., Wi-Fi, 3G, and 4G LTE/LTE-A or WiMAX networks). The term “transmission medium” shall be taken to include any intangible medium that can store, encoding, or carrying instructions for execution by the machine, and includes digital or analog communications signals or other intangible medium to facilitate communication of such software.

Other applicable network configurations may be included within the scope of the presently described communication networks. Although examples were provided with reference to a local area wireless network configuration and a wide area Internet network connection, it will be understood that communications may also be facilitated using any number of personal area networks, LANs, and WANs, using any combination of wired or wireless transmission mediums.

The embodiments described above may be implemented in one or a combination of hardware, firmware, and software. For example, the features in the system architecture 1700 of the processing system may be client-operated software or be embodied on a server running an operating system with software running thereon. While some embodiments described herein illustrate only a single machine or device, the terms “system”, “machine”, or “device” shall also be taken to include any collection of machines or devices that individually or jointly execute a set (or multiple sets) of instructions to perform any one or more of the methodologies discussed herein.

Examples, as described herein, may include, or may operate on, logic or several components, modules, features, or mechanisms. Such items are tangible entities (e.g., hardware) capable of performing specified operations and may be configured or arranged in a certain manner. In an example, circuits may be arranged (e.g., internally or with respect to external entities such as other circuits) in a specified manner as a module, component, or feature. In an example, the whole or part of one or more computer systems (e.g., a standalone, client or server computer system) or one or more hardware processors may be configured by firmware or software (e.g., instructions, an application portion, or an application) as an item that operates to perform specified operations. In an example, the software may reside on a machine readable medium. In an example, the software, when executed by underlying hardware, causes the hardware to perform the specified operations.

Accordingly, such modules, components, and features are understood to encompass a tangible entity, be that an entity that is physically constructed, specifically configured (e.g., hardwired), or temporarily (e.g., transitorily) configured (e.g., programmed) to operate in a specified manner or to perform part or all operations described herein. Considering examples in which modules, components, and features are temporarily configured, each of the items need not be instantiated at any one moment in time. For example, where the modules, components, and features comprise a general-purpose hardware processor configured using software, the general-purpose hardware processor may be configured as respective different items at different times. Software may accordingly configure a hardware processor, for example, to constitute a particular item at one instance of time and to constitute a different item at a different instance of time.

Additional examples of the presently described method (e.g. 700), system (e.g. 100), and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

The present disclosure incorporates the following publications/articles by reference:
1. Doll, Christopher N. H., Jan-Peter Muller, and Jeremy G. Morley. 2006. “Mapping Regional Economic Activity from Night-Time Light Satellite Imagery.” Ecological Economics 75-92.
2. ESRI. n.d. How Zonal Statistics Work. Accessed Mar. 7, 2021. https://desktop.arcgis.com/en/arcmap/10.3/tools/spatial-analyst-toolbox/h-how-zonal-statistics-works.htm.
3. Ghosh, T., R. Powell, C. D. Elvidge, K. E. Baugh, P. C. Sutton, and S. Anderson. 2010. “Shedding Light on the Global Distribution of Economic Activity.” The Open Geography Journal 148-161.
4. He, Chunyang, Peijun Shi, Dingyong Xie, and Yuanyuan Zhao. 2010. “Improving the Normalized Difference Built Up Index to Map Urban Built-Up Areas Using a Semiautomatic Segmentation Approach.” Remote Sensing Letters 213-221.
5. Henderson, J. Vernon, Adam Storeygard, and David N. Weil. 2012. “Measuring Economic Growth from Outer Space.” American Economic Association 994-1028.
6. Jean, Neal, Marshall Burke, Michael Xie, W. Matthew Davis, David B. Lobell, and Stefano Ermon. 2016. “Combining Satellite Imagery and Machine Learning to Predict Poverty.” Science 790-794.
7. US Census Bureau. 2017. X-13 ARIMA-SEATS Seasonal Adjustment Program. March 10. Accessed Mar. 4, 2021. census.gov/srd/www/x13as/.
8. US Geological Survey. n.d. USGS Landsat 4 Surface Reflection Tier. Accessed Mar. 4, 2021. https://developers.google.com/earth-engine/datasets/catalog/LANDSAT_LT04_C01_T1_SR.
9. Xi, Chen, and William D. Nordhaus. 2011. “Using Luminosity Data as a Proxy for Economic Statistics.” PNAS 8589-9504.
10. Zha, Y., J. Gao, and S. Ni. 2003. “Use of Normalized Difference Built-Up Index in Automatically Mapping Urban Areas from TM Imagery.” International Journal of Remote Sensing 583-594

1. A computer-implemented method for forecasting macroeconomic trends using geospatial data and a machine learning model, the method comprising:
obtaining images from a satellite imagery catalog;
determining Normalized-Difference Built-Up Index (NDBI) values of one or more zones between various bands of the images;
determining an average of the NDBI values for each zone;
seasonally adjusting the average NDBI values;
obtaining economic data from external sources;
generating a stationarity dataset based on the adjusted NDBI values and the economic data;
generating a statistical relationship model based on the stationarity dataset and economic activity of each zone; and
forecasting a macroeconomic trend based on the statistical relationship model and the current satellite imagery data.

2. The method of claim 1, wherein the macroeconomic trend is Gross Domestic Product (GDP).

3. The method of claim 1, wherein the statistical relationship model is based on at least one machine learning algorithm.

4. The method of claim 3, wherein the machine learning algorithm is a regression algorithm.

5. The method of claim 1, wherein the external sources include Federal Reserve Bank of St. Louis (FRED) and the Bureau of Economic Analysis (BEA).

6. The method of claim 1, wherein the satellite imagery catalog is Google Earth Engine.

7. The method of claim 1, wherein each zone is a state of the United States.

8. The method of claim 1, comprising:
compiling and/or exporting the macroeconomic trend to an external destination.

9. The method of claim 8, wherein the external destination is a user-access portal that allows authenticated users to view and download the macroeconomic trend.

10. The method of claim 8, wherein the external destination is a blockchain based distributed ledger that records the macroeconomic trend.

11. A system for forecasting macroeconomic trends using geospatial data a machine learning model, the system comprising a processor and a memory, the memory storing computer-executable instructions which are executed by the processor to:
obtain images from a satellite imagery catalog;
determine Normalized-Difference Built-Up Index (NDBI) values of one or more zones between various bands of the images;
determine an average of the NDBI values for each zone;
seasonally adjust the average NDBI values;
obtain economic data from external sources;
generate a stationarity dataset based on the adjusted NDBI values and the economic data;
generate a statistical relationship model based on the stationarity dataset and economic activity of each zone; and
forecast a macroeconomic trend based on the statistical relationship model and the current satellite imagery data.

12. The system of claim 11, wherein the macroeconomic trend is Gross Domestic Product (GDP).

13. The system of claim 11, wherein the statistical relationship model is based on at least one machine learning algorithm.

14. The system of claim 11, wherein the machine learning algorithm is a regression algorithm.

15. The system of claim 11, wherein the external sources include Federal Reserve Bank of St. Louis (FRED) and the Bureau of Economic Analysis (BEA).

16. The system of claim 11, wherein the satellite imagery catalog is Google Earth Engine.

17. The system of claim 11, wherein each zone is a state of the United States.

18. The system of claim 11, wherein the macroeconomic trend is compiled and/or exported to an external destination.

19. The system of claim 18, wherein the external destination is a user-access portal that allows authenticated users to view and download the macroeconomic trend.

20. The system of claim 19, wherein the external destination is a blockchain based distributed ledger that records the macroeconomic trend.
